(19) United States
(12) Patent Application Publication
(10) Pub. No.: US 2015/0060346 A1
(43) Pub. Date: Mar. 5, 2015

(54) Hood for Preventing the Discharge of Debris from a Wastewater Collection Basin

(71) Applicant: Jason Bailey, Reading, PA (US)

(72) Inventor: Jason Bailey, Reading, PA (US)

(73) Assignee: BRENTWOOD INDUSTRIES, INC., Reading, PA (US)

(21) Appl. No.: 14/015,677

(22) Filed: Aug. 30, 2013

(51) Int. Cl. B01D 17/02

(52) U.S. Cl. CPC B01D 17/0214
USPC 210/238; 210/232

(57) ABSTRACT

An oil and debris separation hood mounts on the interior surface of a wastewater collection basin to cover the outlet opening and prevent hydrocarbons, debris and other pollutants from being discharged from the collection basin. The hood device includes a rounded body portion formed with a mounting flange extending along the back side of the hood device from a bottom edge and over the top portion. The upper portion of the hood device includes an access port closed by a sealable lid to provide access to the outlet pipe without removing the hood device from the collection basin. The top portion of the mounting flange is formed with a built-in vent opening that allows the pressure within the hood device to be equalized to the ambient air. The hood device can be formed from plastic sheet material through thermoforming techniques, and includes strengthening ribs and a hand grip.

### FIELD OF THE INVENTION

This invention relates to a device that prevents debris and other contaminates in storm water from discharging through an outlet, and more particularly, to a hood that is mounted on the wall of a collection basin to protect the discharge outlet from discharging floating debris, including liquid contaminates having a specific gravity lower than water, on the surface of the collected storm water.

### BACKGROUND OF THE INVENTION

Separator hoods have been developed to mount on the wall of a collection basin to cover a discharge outlet and prevent the floatable debris carried into the collection basin by storm water from being discharged from the collection basin through the discharge outlet. Prior to separator hoods, collection basins were constructed with baffles that prevented the floatable debris from reaching the outlet pipe. Examples of baffles and of the separator hoods are noted below.

Collection basins, such as a grease trap, septic tanks, storm water catch basins and other types of structures adapted to collect water, such as storm water, carrying floatable debris, which can include trash and also liquid contaminates having a specific gravity lower than water so that the contaminate, such as oil, and other petroleum products, floats on top of the collected water, are typically provided with an inlet that is physically positioned higher than an outlet, so that the collected water and debris will accumulate within the collection basin before being discharge to a remote location through the outlet. In the collection basins represented in U.S. Pat. No. 3,904,524, granted on Sep. 9, 1975, to Sterling Pelton, et al; in U.S. Pat. No. 5,505,860, granted on Apr. 9, 1996, to Robert Sager; in U.S. Pat. No. 5,560,826, granted on Oct. 1, 1996, to Pat Szereday, et al; and in U.S. Pat. No. 6,350,374, granted on Feb. 26, 2002, to R. Russell Stever, et al, the collection basin is formed or constructed with at least one vertically oriented baffle between the inlet and outlet openings so that floatable debris cannot continue unobstructed from the inlet to the outlet and be discharged therefrom. Therefore, the floatable debris is separated from the discharged water on the principle of differential specific gravity.

In the situation of storm water collection, the storm water runs off of highways, parking lots, etc, into a storm water catch basin. The collected storm water will typically carry floatable debris into the storm water catch basin. The floatable debris collected with storm water is usually oil and floatable trash, which accumulate on the surface of the storm water within the storm water catch basin. The storm water will also carry contaminates that have a specific gravity greater than water and such contaminates, typically settle on the bottom of the storm water catch basin as solids, which can include materials that are too large and too heavy to be suspended in the wastewater and very fine particles which are suspended in the storm water but tend to settle to the bottom of the catch basin given a sufficient length of time to do so.

A hood for separating oil and floatable debris from storm water is disclosed in U.S. Pat. No. 6,126,817, granted on Oct. 3, 2000, to Lee Duran, et al, in which a polymeric hood is attached to the wall of the storm water catch basin over the outlet pipe so that water has to flow under the hood to reach the outlet pipe. Since the floatable debris is blocked by the hood from reaching the outlet pipe, the floatable debris and any petroleum products floating on top of the surface of the storm water will be retained in the storm water catch basin. The hood in the '817 patent is provided with a vent in the main body of the hood and an extension that positions the vent opening above the surface of the hood and, thus, above the surface of the storm water within the catch basin so that the pressure within the hood will be equalized with the pressure within the storm water catch basin when the level of the storm water rises above the bottom opening of the hood. In addition, the hood disclosed in the '817 patent has a sealed access port formed in the front of the body portion to allow for cleaning within the hood. The hood is sealed against the wall of the storm water catch basin by a seal captured by a flange through which fasteners are inserted to secure the hood to the vertical wall of the catch basin around the outlet pipe.

In U.S. Pat. No. 7,951,294, granted on May 31, 2011, to Lee Duran, et al, an oil and debris separator configured to fit into a circular collection basin is disclosed. The body portion includes a mounting flange that is oriented to engage the interior surface of a circular collection basin to cover the outlet pipe in a manner that prevents debris from passing into the outlet pipe as the wastewater in the collection basin flows below the bottom of the body of the hood. The upper portions of the body of the hood include an access port covered by a removable lid and a vent tube built into the body to allow the hood to communicate with the ambient air to equalize pressures within the hood and facilitate the movement of wastewater into the outlet pipe. In U.S. Pat. No. 7,857,966, granted to Lee Duran, et al, on Dec. 28, 2010, the oil and debris separator hood has mounted thereon a skirted boom to extend below the bottom of the hood to provide extended restriction of the passage of debris into the outlet pipe while the skirted boom absorbs hydrocarbons, such as oil, within the wastewater surrounding the hood.

The incorporation of a vent into the body of the hood to equalize the pressure within the sealed hood to the ambient pressure within the collection basin, and thus facilitate the flow of wastewater below the bottom flange of the hood and into the outlet pipe is not included in all oil and debris separating hoods, as can be seen in the storm water trap marketed by Advanced Drainage Systems, Inc. as the EnviroHood™ Unit. However, in the hood devices noted above, the incorporation of a separate structure projecting upwardly from the body of the hood device is not conducive to being manufactured by thermoforming techniques.

It would be desirable to provide a hood device for covering the outlet pipe in a wastewater collection basin in which the hood device would incorporate a vent in a configuration that is conducive to being formed from thermoformed polymeric material, such as high density polyethylene (HDPE) sheeting.

### SUMMARY OF THE INVENTION

It is an object of this invention to provide an improved oil and debris separation hood for use in a collection basin to prevent debris and hydrocarbons from being discharged from the collection basin through the outlet pipe.

It is another object of this invention to provide an oil and debris separation hood that is configured to being manufactured through thermoforming techniques.

It is an advantage of this invention that the oil and debris separation hood is formed with a built-in vent that equalizes pressure within the interior of the hood with the ambient air within the collection basin within which the hood is deployed.

It is a feature of this invention that the oil and debris separation hood is formed with a vent formed into the top portion of the mounting flange formed around the perimeter of the hood.

It is another feature of this invention that the hood is formed with a mounting flange along the periphery of the hood that is engaged with the surface of the collection basin to allow a mounting of the hood to the collection basin.

It is another advantage of this invention that the mounting flange around the periphery of the oil and debris separation hood can be sealed with a gasket against the interior surface of the collection basin.

It is still another feature of this invention that the upper portion of the body of the hood device is formed with an access port to permit access to the outlet pipe of the catch basin without requiring removal of the hood from the interior surface of the collection basin.

It is still another advantage of this invention that the access port can be covered by a removable lid that is sealed against the body of the hood device.

It is still another object of this invention to provide an oil and debris separation hood that can be formed of thermoformed polymeric material, such as high density polyethylene (HDPE) sheeting.

It is yet another feature of this invention that the body of the hood device is formed with strengthening ribs to provide structural integrity when the hood device is mounted on the interior surface of a collection basin.

It is still another feature of this invention that the body of the hood device is also formed with a hand grip to facilitate handling of the hood device during transport to and during installation on the interior surface of a collection basin.

It is another feature of this invention that manufacturing the hood device through thermoforming techniques enables the hood device to be formed during the manufacturing process with fastener openings within the mounting flange around the periphery of the hood device to assist in the installation of the hood device onto the interior of a collection basin.

It is yet another object of this invention to provide an oil and debris separation hood for installation over the outlet opening of a wastewater collection basin which is durable in construction, inexpensive of manufacture, carefree of maintenance, facile in assemblage, and simple and effective in use.

These and other objects, features and advantages are accomplished according to the instant invention by providing an oil and debris separation hood device for mounting on the interior surface of a wastewater collection basin to cover the outlet opening and prevent hydrocarbons, debris and other pollutants from being discharged from the collection basin. The hood device includes a rounded body portion formed with a mounting flange extending along the back side of the hood device from a bottom edge and over the top portion. The upper portion of the hood device includes an access port closed by a sealable lid to provide access to the outlet pipe without removing the hood device from the collection basin. The top portion of the mounting flange is formed with a built-in vent opening that allows the pressure within the hood device to be equalized to the ambient air within the collection basin. The hood device can be formed from plastic sheet material through thermoforming techniques, and includes strengthening ribs and a hand grip.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a left, front perspective view of an oil and debris separation hood incorporating the principles of the instant invention;

FIG. 2 is a right, front perspective view of the oil and debris separation hood shown in FIG. 1;

FIG. 3 is a left, rear perspective view of the oil and debris separation hood shown in FIG. 1;

FIG. 4 is a front elevational view of the hood device shown in FIG. 1;

FIG. 5 is a right side elevational view of the hood device shown in FIG. 4;

FIG. 6 is a rear elevational view of the hood device shown in FIG. 4;

FIG. 7 is a top plan view of the hood device shown in FIG. 4;

FIG. 8 is a bottom plan view of the hood device shown in FIG. 4;

FIG. 9 is a representative perspective view of a wastewater collection basin with a portion of the wastewater collection basin broken away for purposes of clarity; and

FIG. 10 is a representative perspective view of the oil and debris separation hood mounted on the interior surface of the wastewater collection basin as shown in FIG. 9.

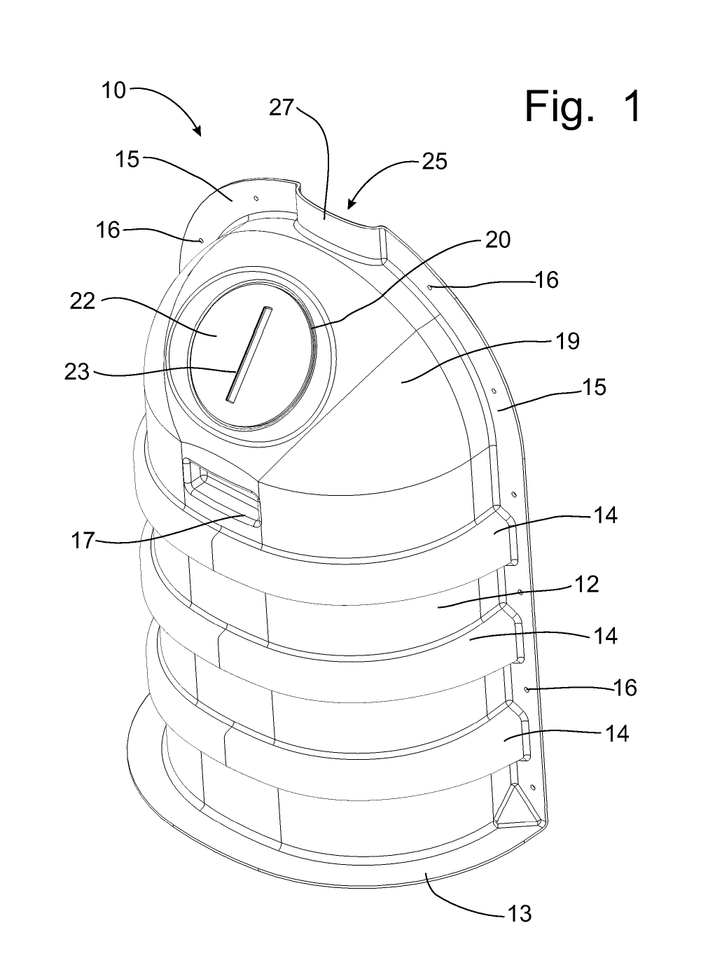

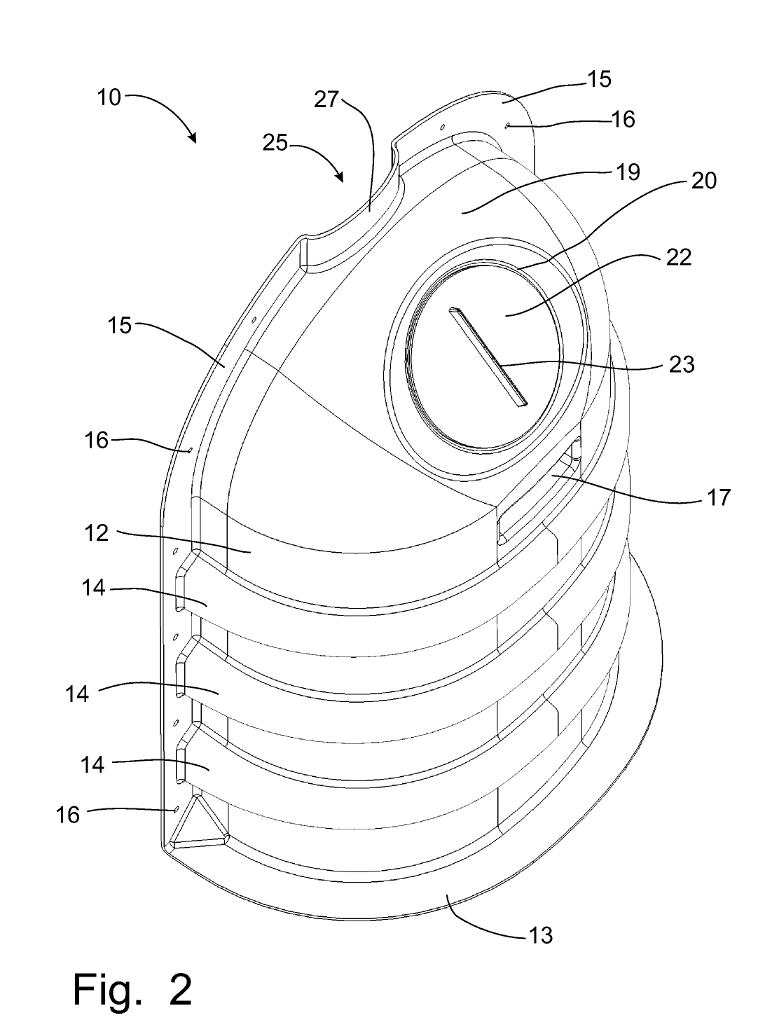

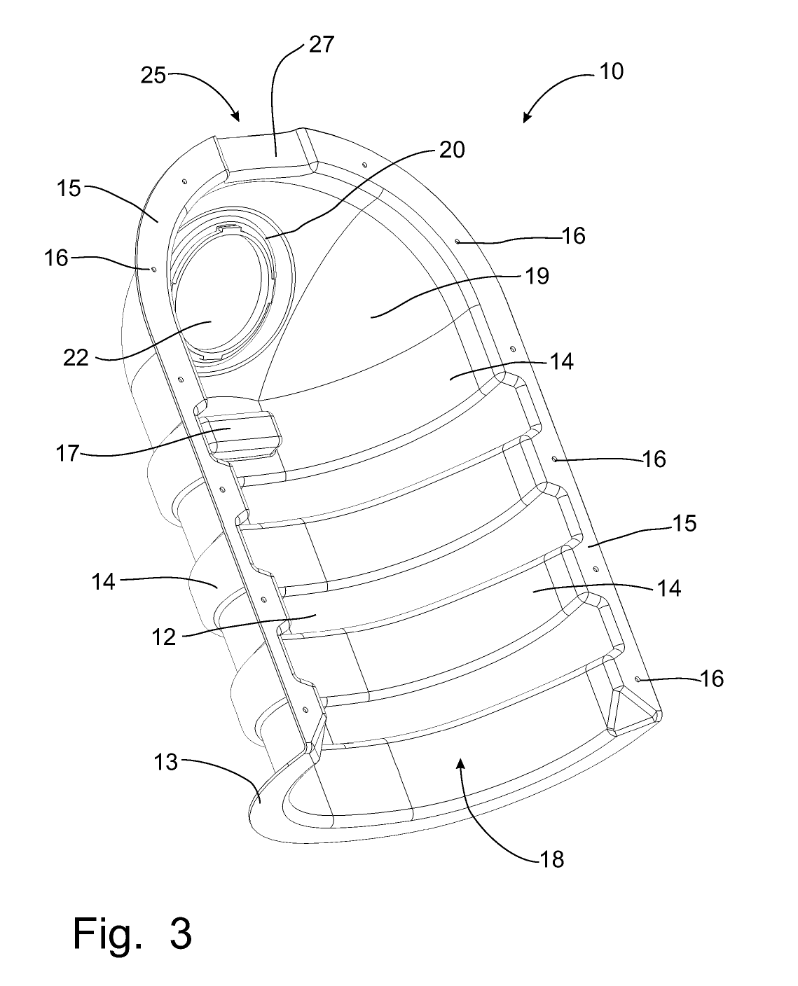

### DETAILED DESCRIPTION OF THE PREFERRED EMBODIMENT

Referring to the drawings, an oil and debris separation hood device incorporating the principles of the instant invention can best be seen. Any left and right references are used as a matter of convenience and are determined from the reference point of the interior surface of the wastewater collection basin 30 and looking toward the interior of the collection basin such that the mounting flange 15 contacting the interior surface of the collection basin is located along the rear of the hood device 10 and the front of the hood projects into the interior of the collection basin. The hood device 10 is preferably formed from polymeric material, such as high density polyethylene (HDPE) sheeting, having a thickness of approximately a quarter of an inch (0.25″) by thermoforming techniques.

The hood device 10 is formed with a rounded body 12 bent around a generally vertical axis to project forwardly from a rearwardly positioned mounting flange 15 formed around the periphery of the body 12 that engages the interior surface of the wastewater collection basin, as will be described in greater detail below. The rounded body 12 includes a generally horizontal bottom periphery flange 13 that defines the lower edge of an interior cavity 18 of the hood device 10. The rounded body 12 includes a plurality of vertically spaced strengthening ribs 14, which along with the lower periphery flange 13 are formed into the rounded body 12 to provide structural stability and integrity for the body portion 12. Preferably, the forward portion of the rounded body 12 is also formed with a hand grip 17 which can be formed as an indent into the body 12. The hand grip 17 can also be formed into the sides of the body 12 and facilitate the manipulation of hood device 10 during transportation to and installation in a wastewater collection basin 30.

The body 12 is also formed with a rounded upper portion 19, bending around a forwardly extending axis, capping the interior cavity 18, which connects one side of the body 12 to the opposing side. The upper portion 19 is formed with an access port 20 that is closed by a removable lid 22 that seals against the body 12 through the engagement between the lid 22 and the access port 20 within the upper portion 19. The lid 22 can be threaded into the access port 20 or secured to the access port through a cam arrangement that presses the lid 22 against the perimeter of the access port to squeeze lid 22 against the access port 20 to establish a fluid tight, or at least close to fluid tight, engagement between the lid 22 and the access port 20. The lid 22 can be formed with a slot 23 therein to permit the insertion of a tool, such as a screw driver, to rotate the lid 22 and open the access port 20. Furthermore, the lid 22 can be formed with a handle to facilitate handling of the lid 22 into and out of engagement with the access port 20.

The mounting flange 15 extends around the rear side of the body 12 along a vertical plane from the bottom periphery flange 13 at one side of the body 12, around the upper portion 19 and back to the bottom periphery flange 13 at the opposing side of the body 12. The mounting flange 15 is preferably formed with fastener openings 16 spaced along the mounting flange 15 for the passage of fasteners (not shown) that connect the hood device 10 to the interior surface of the wastewater collection basin 30. Preferably, the hood 10 is manufactured through thermoforming operations, following which the body 12 is trimmed and the fastener openings 16 are pre-drilled into the mounting flange 15 before shipment to the customer.

The top portion of the mounting flange 15 at the apex of the upper rounded portion 19, is formed with a built-in vent opening 25 that allows the air pressure within the interior cavity 18 of the hood device 10, once the bottom periphery flange 13 is immersed in wastewater, to be equal to the ambient pressure within the wastewater collection basin 30 so that the level of the wastewater internally of the hood device 10 will be the same as the level of the wastewater within the collection basin 30. The vent 25 is formed by a bend in the top portion of the mounting flange 15 that pushes a corresponding top portion 27 of the mounting flange 15 forwardly of the plane defined by the remaining portions of the mounting flange 15. As a result, the corresponding top portion 27 of the mounting flange 15 does not contact the interior surface of the wastewater collection basin 30 and, thus, leaves a vent opening 25 into the interior of the hood device 10.

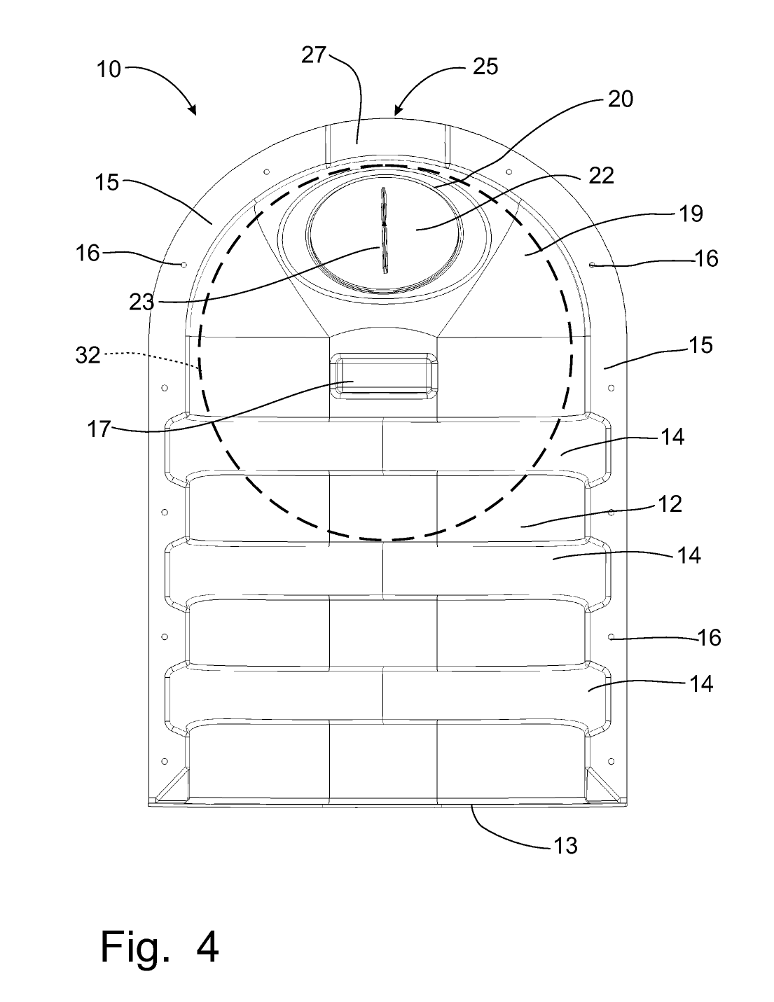

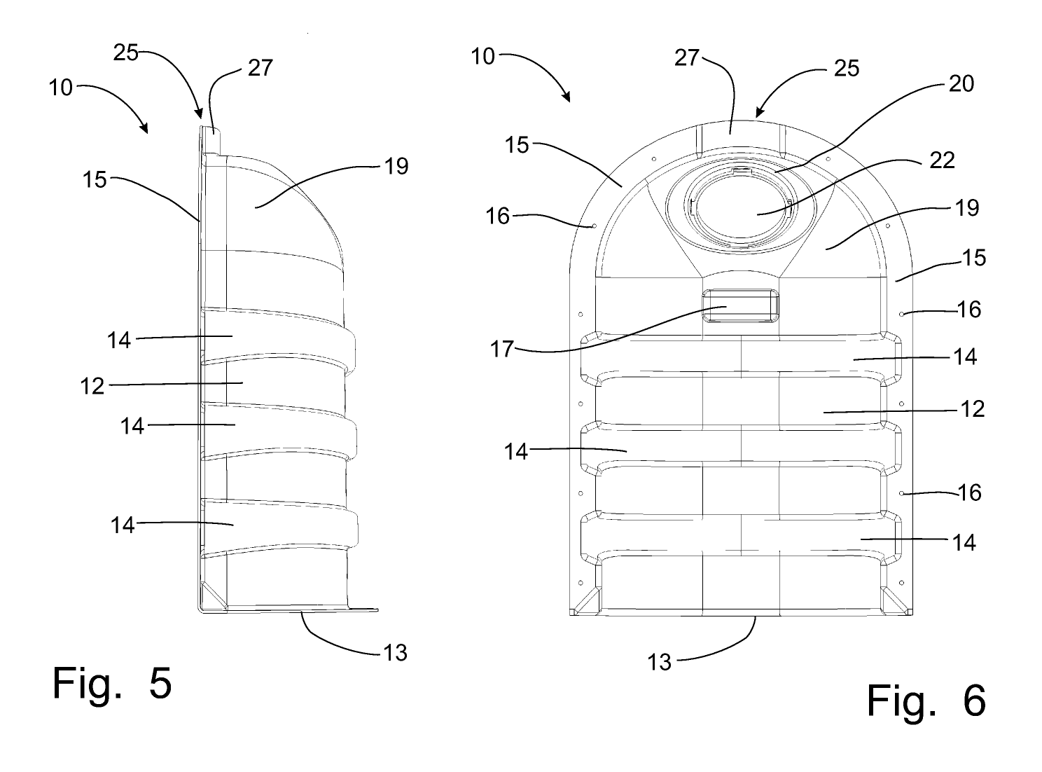

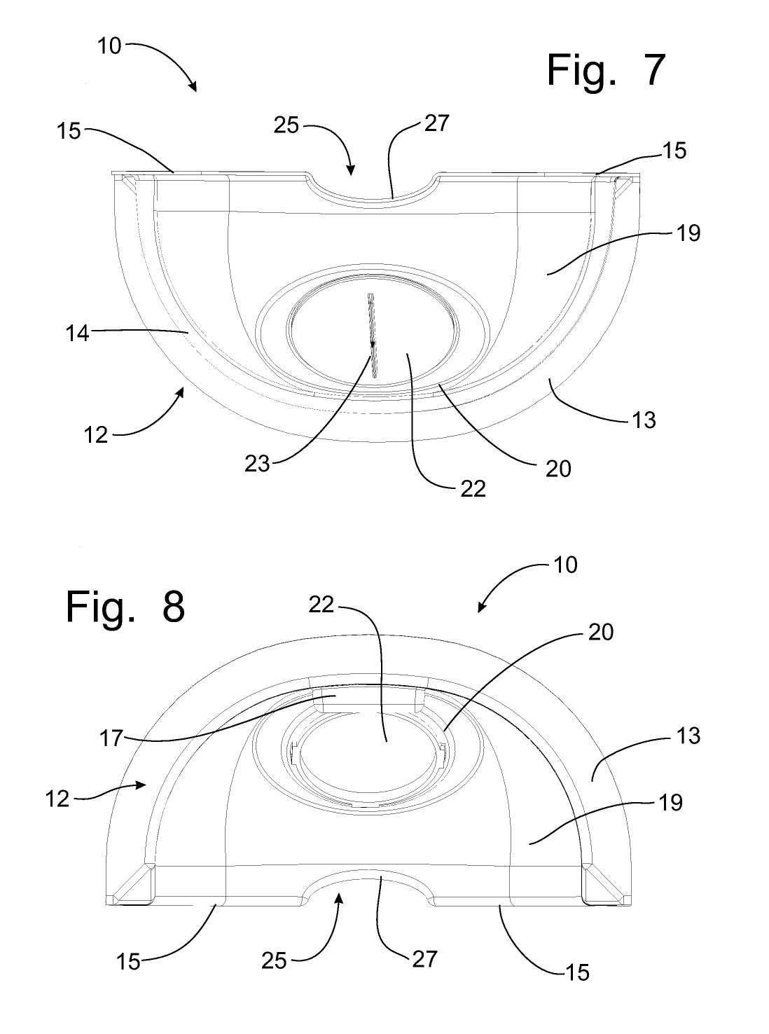

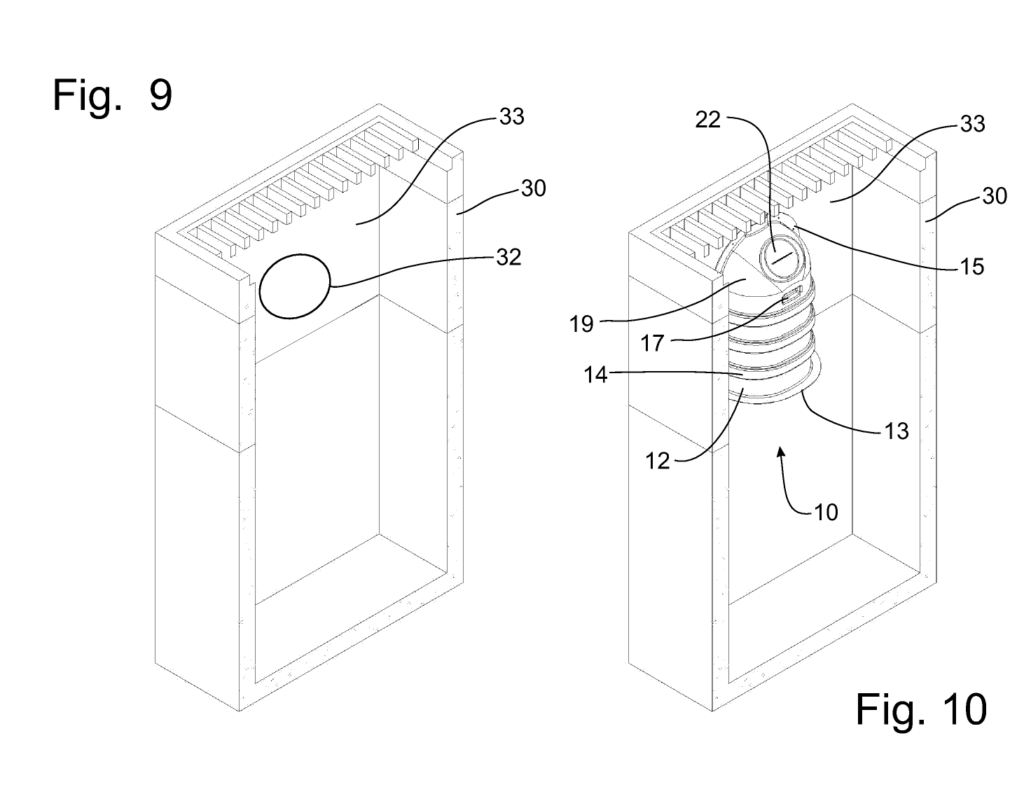

As is best seen in FIGS. 4, 9 and 10, the hood device 10 is installed on the interior surface 33 of the wastewater collection basin 30 around the outlet opening 32 which is connected to a conduit to convey the wastewater from the collection basin 30 to a remote location. The hood device 10 is secured to the interior surface 33 of the collection basin 30 by fasteners that pass through the fastener openings 16 formed in the mounting flange 15. The hood device is located on the interior surface 33 such that the mounting flange 15 surrounds the upper and sides of the outlet opening 32, allowing the passage of water underneath the lower periphery flange, into the interior cavity 18 and discharge through the outlet opening 32. Preferably, a foam or neoprene seal, or gasket, (not shown) will be placed between the rear side of the mounting flange 15 and the interior surface 33 of the wastewater collection basin 30 to seal the engagement of the hood device 10 with the interior surface 33 of the collection basin 30 in order to prevent the passage of wastewater into the interior cavity 18 except by passing underneath the lower periphery flange 13.

Once installed as indicated above, wastewater, such as storm water, is received in the collection basin 30 and fills the collection basin 30 to the level of the outlet opening 32, submerging the lower periphery flange 13 in water. Any debris or hydrocarbons entering the collection basin 30 with the storm water runoff will usually float to the top surface of the collected water. Any debris that is not buoyant will sink to the bottom of the collection basin 30 and collect there until cleaned out at a subsequent date. The hood device 10 prevents the flow of debris and hydrocarbons into the outlet opening 32 by presenting a barrier between the debris and the outlet opening 32. Since the vent 25 equalizes the air pressure within the internal cavity 18 and since the mounting flange 15 is sealed against the interior surface 33 of the collection basin 30, the level of the collected wastewater will be the same within the interior cavity 18 as in the collection basin 30 outside of the hood device 10. As a result, the flow of the wastewater to be discharged from the collection basin 30 through the outlet opening 32 must pass into the interior cavity 18 from underneath the bottom periphery flange 13, keeping the debris and hydrocarbons from reaching the outlet opening and being conveyed to the remote location.

The size of the hood device 10 depends on the size of the outlet opening 32 to be covered by the hood 10. For outlet openings 32 having a diameter of 18 inches, the overall height of the hood 10 can be 29 inches with the width at 23 inches and the depth from the mounting flange to the front of the rounded body 12 being at 12 inches. Similarly, an outlet opening having a diameter of 24 inches would require a hood device 10 with a height of 39 inches, a width of 37 inches and a depth of 12 inches, while an outlet opening having a diameter of 30 inches would require a hood having a height of 45 inches, a width of 40 inches and a depth of 16 inches.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. An apparatus for mounting around an outlet of a wastewater collection basin which receives wastewater carrying pollutants having a specific gravity that is lower than that of water so as to float on the water, comprising:
a body having a rearward mounting flange and defining an interior cavity terminating at a bottom periphery flange as an opening into said interior cavity, said mounting flange being connected to and sealed against said wastewater collection basin to force the movement of wastewater underneath said bottom periphery flange to enter said outlet; and
a vent formed in said mounting flange at a top portion thereof so as to be located above said outlet when said apparatus is mounted to said wastewater collection basin to provide equalization of air pressure between said interior cavity and said collection basin.

2. The apparatus of claim 1 wherein said vent is formed as a bent portion of said mounting flange that is spaced from said wastewater collection basin.

3. The apparatus of claim 2 wherein said body is rounded about a generally vertical axis such that said body projects forwardly from said mounting flange to define said interior cavity.

4. The apparatus of claim 2 wherein said body is formed with generally horizontally oriented strengthening ribs spaced vertically above said bottom periphery flange.

5. The apparatus of claim 4 wherein said body also includes an upper portion that is rounded about a forwardly extending axis.

6. The apparatus of claim 5 wherein said upper portion includes an access port that opens into said interior cavity, said access port being closed by a removable lid.

7. The apparatus of claim 6 wherein said mounting flange is sealed against said wastewater collection basin to prevent water from passing between said mounting flange and said wastewater collection basin.

8. The apparatus of claim 7 wherein said body portion is formed with a hand grip indented into said interior cavity.

9. The apparatus of claim 8 wherein said apparatus is formed through thermoforming manufacturing techniques.

10. A molded hood for mounting on an interior surface of a wastewater collection basin to cover an outlet opening and prevent debris floating within the wastewater collected within said wastewater collection basin from reaching said outlet opening, said molded hood comprising:
a body having a forwardly rounded configuration defining an interior cavity terminating at a rearward, vertically oriented mounting flange and at a bottom, generally horizontally oriented periphery flange, said bottom periphery flange defining a vertical opening into said interior cavity for the passage of wastewater from said wastewater collection basin into said outlet opening; and
said mounting flange including a built-in vent at a top portion thereof so as to be located above said outlet opening when said hood is mounted to said interior surface of said wastewater collection basin, said vent being formed by a bend in said mounting flange that pushes said top portion forwardly of a plane defined by a remaining portion of said mounting flange, said vent being operable to equalize air pressure between said interior cavity and said wastewater collection basin.

11. The hood of claim 10 wherein said body is rounded about a generally vertical axis such that said body projects forwardly from said mounting flange to define said interior cavity.

12. The hood of claim 11 wherein said body is formed with generally horizontally oriented strengthening ribs spaced vertically above said bottom periphery flange.

13. The hood of claim 10 wherein said body also includes an upper portion that is rounded about a forwardly extending axis.

14. The hood of claim 13 wherein said upper portion includes an access port that opens into said interior cavity, said access port being closed by a removable lid.

15. The hood of claim 10 wherein said mounting flange is sealed against said wastewater collection basin to prevent water from passing between said mounting flange and said wastewater collection basin.

16. The hood of claim 10 wherein said body portion is formed with a hand grip indented into said interior cavity.

17. A molded hood for mounting on an interior surface of a wastewater collection basin to cover an outlet opening and prevent debris floating within the wastewater collected within said wastewater collection basin from reaching said outlet opening, said molded hood comprising:
a body having a forwardly rounded configuration bent around a generally vertical axis and a rounded upper portion bent around a generally forwardly extending axis to define an interior cavity open at a bottom edge for the passage of wastewater into said interior cavity, said body including:
a rearward, generally vertical mounting flange oriented in a generally vertical plane;
a bottom, generally horizontal periphery flange at said bottom edge;
a vent at a top portion of said mounting flange formed by a bend in said mounting flange that pushes said top portion forwardly of the plane of said mounting flange such that said top portion is not in contact with said wastewater basin when said hood is mounted thereon, said vent being operable to equalize air pressure between said interior cavity and said wastewater collection basin; and
an access port formed in said upper portion to allow access to said outlet opening without requiring removal of said hood from said wastewater collection basin, said access port being closed by a removable lid.

18. The hood of claim 17 wherein said body further includes generally horizontally oriented strengthening ribs spaced vertically above said bottom periphery flange.

19. The hood of claim 18 wherein said body further includes a hand grip indented into said interior cavity.

20. The hood of claim 19 wherein said mounting flange is formed with fastener openings through which fasteners can be inserted to attach the hood to said wastewater collection basin.
